(19) United States
(12) Patent Application Publication
(10) Pub. No.: US 2026/0244500 A1
(43) Pub. Date: Aug. 20, 2026

(54) SOFT QUOTAS FOR CLOUD RESOURCE MANAGEMENT

(71) Applicant: Dell Products L.P., Round Rock, TX (US)

(72) Inventors: Michael Baptist, Boise, ID (US); Steven Soumpholphakdy, Austin, TX (US)

(21) Appl. No.: 19/057,337

(22) Filed: Feb. 19, 2025

(51) Int. Cl. G06F 9/50

(52) U.S. Cl. CPC G06F 9/5027

(57) ABSTRACT

The subject technology relates to soft quotas for cloud resource management. An example method includes, in response to a request to deploy a cluster via a cloud computing service, comparing a requested amount of a computing resource associated with the cluster to an unreserved amount of the computing resource allocated to the cloud computing service, the unreserved amount defined as a difference between a total amount of the computing resource allocated for the cloud computing service and an amount of the computing resource reserved by virtual machines associated with the cloud computing service; in response to the unreserved amount of the computing resource being greater than or equal to the requested amount, incrementing the reserved amount by the requested amount and facilitating deployment of the cluster; and, in response to the unreserved amount being less than the requested amount, denying the request to deploy the cluster.

### BACKGROUND

In a fully managed cloud deployment, such as those associated with a software-as-a-service (SaaS) platform, the SaaS provider can consume resources (e.g., storage units, processing units, etc.) associated with a cloud provider. A quota, referred to herein as a “hard quota,” defines the amount of a resource that is allocated to the SaaS provider from the cloud provider. The SaaS provider can query their quota in the cloud platform to determine how much of a specific resource is free or in use at an instance in time. Additionally, in certain maintenance and lifecycle management workflows, resources may need to be deallocated, released, or created, which can increase or decrease the available resources within the total quota.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include comparing, in response to a request to create a new deployment associated with a cloud computing service, a requested amount of a computing resource associated with the new deployment to a difference between a resource quota of the computing resource as allocated for the cloud computing service and a reserved amount of the computing resource reserved by virtual machines (VMs) associated with the cloud computing service. The operations can also include, in response to the difference being determined not to be less than the requested amount of the computing resource, incrementing the reserved amount of the computing resource by the requested amount of the computing resource and enabling creation of the new deployment within the cloud computing service. The operations can further include, in response to the difference being determined to be less than the requested amount of the computing resource, denying the request to create the new deployment.

In another implementation, a method is described herein. The method can include, in response to a request to deploy a cluster via a cloud computing service, comparing, by a system including at least one processor, a requested amount of a computing resource associated with the cluster to an unreserved amount of the computing resource allocated to the cloud computing service, the unreserved amount of the computing resource defined as a difference between a total amount of the computing resource allocated for the cloud computing service and a reserved amount of the computing resource reserved by virtual machines associated with the cloud computing service. The method can further include, in response to the unreserved amount of the computing resource being greater than or equal to the requested amount, incrementing, by the system, the reserved amount of the computing resource by the requested amount and facilitating deployment of the cluster via the cloud computing service. The method can additionally include, in response to the unreserved amount of the computing resource being less than the requested amount, denying, by the system, the request to deploy the cluster.

In an additional implementation, a non-transitory machine-readable medium is described herein that can include instructions that, when executed by at least one processor, facilitate performance of operations. The operations can include, in response to a request to create a deployment associated with a cloud computing service, comparing a requested amount of a computing resource associated with the deployment to an available amount of the computing resource allocated to the cloud computing service, where the available amount of the computing resource is determined as a difference between a total amount of the computing resource allocated for the cloud computing service and a reserved amount of the computing resource reserved by deployed virtual machines associated with the cloud computing service; in response to the available amount of the computing resource being determined not to be less than the requested amount, incrementing the reserved amount of the computing resource by the requested amount and initiating creation of the deployment via the cloud computing service; and in response to the available amount of the computing resource being determined to be less than the requested amount, denying the request to create the deployment.

### DESCRIPTION OF DRAWINGS

Various non-limiting embodiments of the subject disclosure are described with reference to the following figures, wherein like reference numerals refer to like parts throughout unless otherwise specified.

FIGS. 1-4 are block diagrams of respective systems that facilitate soft quotas for cloud resource management in accordance with various implementations described herein.

FIGS. 5A-5B, 6A-6B, and 7 are diagrams illustrating respective procedures that can be utilized in connection with one or more implementations described herein.

FIG. 8 is a block diagram of another system that facilitates soft quotas for cloud resource management in accordance with various implementations described herein.

FIGS. 9A-9B are diagrams illustrating another procedure that can be utilized in connection with one or more implementations described herein.

FIGS. 10-11 are flow diagrams of respective methods that facilitate soft quotas for cloud resource management in accordance with various implementations described herein.

FIG. 12 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Various implementations described herein can provide techniques to facilitate enhanced cloud resource management, e.g., through the use of “soft quotas” as will be described below. As noted above, a cloud provider can impose limitations on cloud computing resources consumed by a given SaaS provider in the form of a quota, referred to herein as a “hard quota.” By way of example, hard quotas can be set by a cloud provider for resources such as processor units (e.g., central processing units or CPUs), storage volumes or devices, and/or any other suitable type of finite resource that is desirably limited by a cloud provider. While various implementations are described herein with respect to quotas for CPUs, it is noted that CPUs are merely one example of a resource that can be managed as described herein, and that this description and the claimed subject matter are not intended to be limited to any specific resource type(s) unless explicitly stated otherwise.

In general, a subscriber to a software-as-a-service (SaaS) solution expects that their resources are reserved for them once they have subscribed. However, in certain maintenance and lifecycle management (e.g., add capacity) workflows, resources may desirably be deallocated, released, and/or created, and these operations can increase or decrease the available resources within the total quota allocated by the cloud provider. This can lead to various quota-related issues that can potentially leave a cluster associated with a service subscriber in an unhealthy state.

As a first example of the above, issues can arise when a deployment that has already contracted for and received a given level of resources needs to undergo maintenance, e.g., in which resources are temporarily taken offline. This can be problematic because the subscriber has paid for resources that are shown as free to the SaaS provider software, and these resources may be used elsewhere by the same software or orchestration system due to the orchestration system being unaware that those resources should be saved for the subscriber while maintenance is ongoing.

As another example, issues can also arise when a subscriber requests a deployment update, such as a capacity addition. In such cases, it is desirable to provide a mechanism to be able to confirm that resources are available without having them taken away during an update operation. For instance, creation of a new virtual machine (VM) can consume an additional part of an existing resource quota, but because VM creation can happen asynchronously, multiple subscribers could potentially request creation of a new VM when sufficient resources do not exist to fulfill all of the requests. In such a scenario, a cloud provider that utilizes conventional techniques for resource orchestration may accept all of the requests and attempt to allocate resources to each of them, resulting in failure of at least some of the requests after those requests have already been accepted. This can result in significantly diminished user experience, e.g., due to resource management operations failing in a manner that appears random or otherwise unexpected from the perspective of a user.

To the furtherance of the above and/or related ends, various implementations described herein can utilize “soft” quotas, which can be implemented via a software algorithm and enable a SaaS provider to reserve resources in their software solution for subscribers. This can enable a SaaS provider to ensure that another thread, worker, process, etc. of the same software will not use resources that may be reserved for a subscribed customer, even when the provider quota indicates that there are enough free resources to perform an operation or onboard a new subscriber.

The use of soft quotas as described herein can further provide additional advantages that can improve the operation and/or performance of a cloud-based SaaS platform. For instance, various implementations as described herein can give a SaaS platform operator a gauge of the actual and/or intended usage of cloud resources at a given point in time, e.g., as opposed to a simple indicator of the resources that are currently in use. Implementations as described herein can additionally provide improved information relating to the resources that are reserved for use by a given cloud-based platform in real time. For instance, if a SaaS platform has a free quota of 2000 CPUs, and there are pending requests to allocate 700 of those CPUs, subsequent requests to allocate resources can be handled on the basis of the 1300 remaining unreserved CPUs instead of the full CPU quota. Implementations as described herein can further enable a SaaS provider to reserve cloud-based resources for future use. For instance, if a user reserves 400 CPUs but only needs 100 of the CPUs allocated immediately, soft quotas can enable reservation of the full 400 CPU request without allocating the full amount, thereby increasing flexibility. Other advantages of the implementations described herein are also possible.

Moreover, by utilizing one or more implementations as described herein, computing resources associated with a cloud computing platform can be reserved and/or otherwise managed using automated processes that can operate at a higher level of complexity than is possible to be performed manually by a human, e.g., due to the number of calculations and/or other operations performed in parallel, the number of VMs and/or the amount of resources that can be processed simultaneously, and/or other factors. Additionally, implementations described herein can facilitate automation of highly technical tasks that are inherently and/or inextricably tied to computer technology and cannot be implemented outside of a computing environment, such as tasks associated with VM instantiation and de-instantiation, resource allocation and/or deallocation, or other aspects of computing system management. As a result, by utilizing one or more automated techniques facilitated by implementations described herein, resource management tasks for an associated computing system can be initiated via actions such as pressing a button on a user interface, inputting a simple command, or performing other comparable actions, or automatically in response to various triggering events, even if an operator of the system lacks the requisite knowledge to perform those tasks manually.

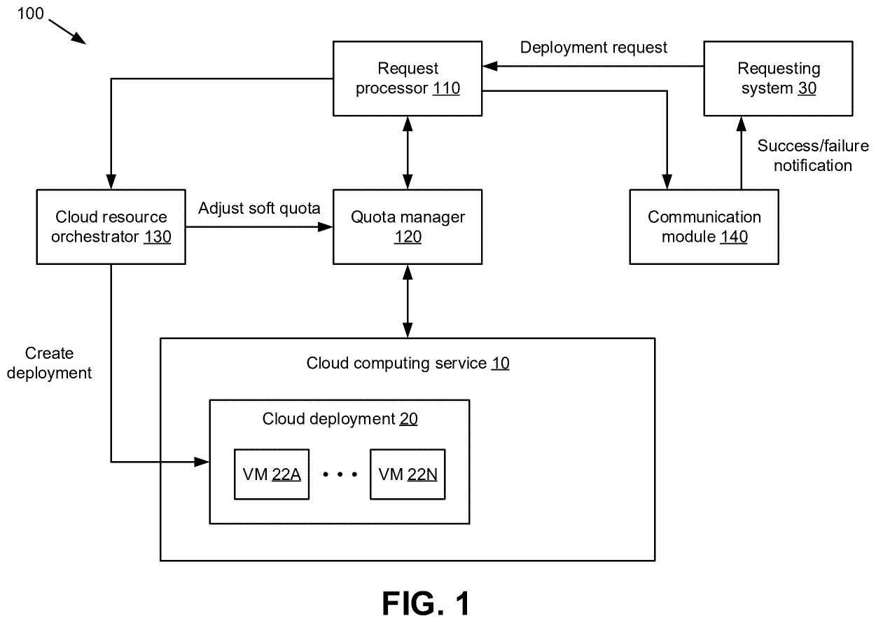

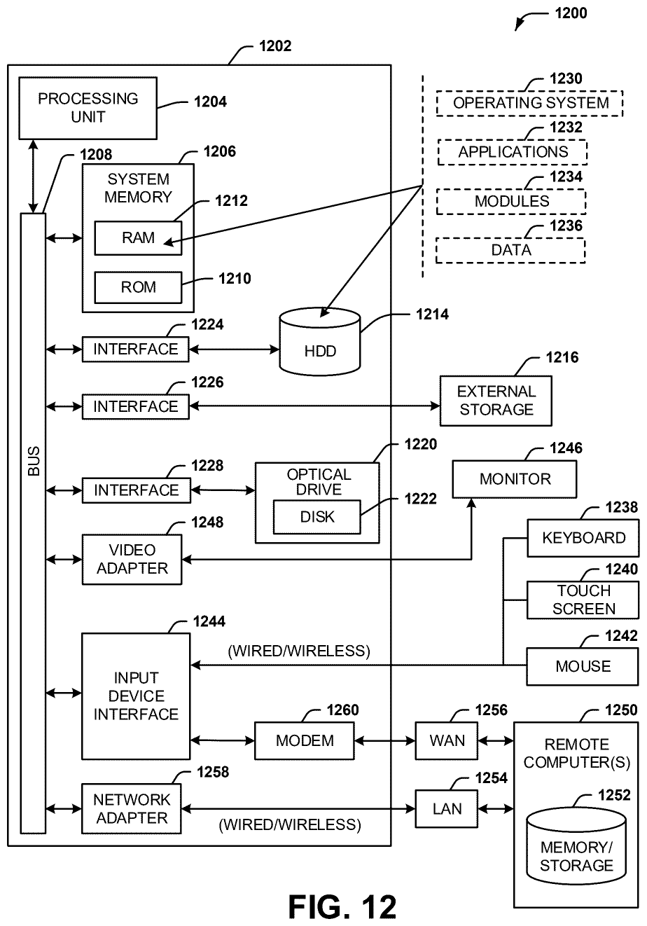

With reference now to the drawings, FIG. 1 illustrates a block diagram of a system 100 that facilitates soft quotas for cloud resource management in accordance with various implementations described herein. System 100 as shown in FIG. 1 includes executable components, e.g., a request processor 110, a quota manager 120, a cloud resource orchestrator 130, and a communication module 140, each of which can operate as described in further detail below. In an implementation, the components 110, 120, 130, 140 of system 100 can be implemented in hardware, software, or a combination of hardware and software. By way of example, the components 110, 120, 130, 140 can be stored on at least one memory and executed by at least one processor. An example of a computer architecture including a processor and memory that can be used to implement the components 110, 120, 130, 140, as well as other components as will be described herein, is shown and described in further detail below with respect to FIG. 12.

Additionally, it is noted that the functionality of the respective components shown and described herein can be implemented via a single computing device and/or a combination of devices. For instance, in various implementations, the request processor 110 shown in FIG. 1 could be implemented via a first device, the quota manager 120 could be implemented via the first device or a second device, the cloud resource orchestrator 130 could be implemented via the first device, the second device, or a third device, and the communication module 140 could be implemented via the first device, the second device, the third device, or a fourth device. Also, or alternatively, the functionality of a single component could be divided among multiple devices in some implementations.

As will be described in further detail below, the components 110, 120, 130, 140 of system 100 can be utilized to control access to and/or otherwise manage resources associated with a cloud computing service 10. The cloud computing service 10 can be implemented via any suitable cloud computing platform, such as Microsoft Azure, Amazon Web Services, and/or any other suitable platform either presently existing or developed in the future. In an implementation, the cloud computing service 10 can be associated with any suitable as-a-service (aaS) solution, such as SaaS, platform-as-a-service (PaaS), infrastructure-as-a-service (IaaS), or the like. In some implementations, some or all of the components 110, 120, 130, 140 of system 100 can be implemented by an aaS solution provider, which can be the same as, or distinct from, a cloud provider associated with the cloud computing service 10. Additionally, while the components 110, 120, 130, 140 of system 100 are illustrated in FIG. 1 as distinct from the cloud computing service 10, it is noted that some or all of the functionality of the components 110, 120, 130, 140 of system 100 could be implemented via resources associated with the cloud computing service 10 and/or other suitable resources, e.g., resources associated with one or more computing devices located at a computing site associated with an aaS solution provider that are capable of communication with the cloud computing service 10 via any suitable communication technology(-ies).

As further shown in FIG. 1, system 100 can be utilized to manage resources associated with one or more deployments 20 created within the cloud computing service 10. In one example, a cloud deployment 20 as managed by system 100 can be and/or otherwise include a cluster of VMs 22 and/or other suitable virtualized computing resources. While a cluster of N VMs 22A-22N is shown in FIG. 1, it is noted that the numbering convention utilized for the VMs 22 in FIG. 1 is not intended to imply any specific number of VMs 22, and that respective cloud deployments 20 could include any suitable number of VMs 22, including one VM 22 or multiple VMs 22.

With reference now to the components of system 100, the request processor 110 can receive a request, e.g., from a requesting system 30 associated with a user of a SaaS platform associated with system 100, to create a new deployment 20 associated with a cloud computing service 10. In an implementation, such a request can be provided by the requesting system 30 to the request processor 110 via one or more interfaces associated with a SaaS (or other aaS) platform provided by system 100. Additionally, a request as shown in FIG. 1 can be routed directly to the request processor 110 without intervention from the cloud computing service 10 and/or its provider, thereby providing system 100 a greater degree of control over incoming deployment requests as compared to conventional service-driven deployment request handling techniques.

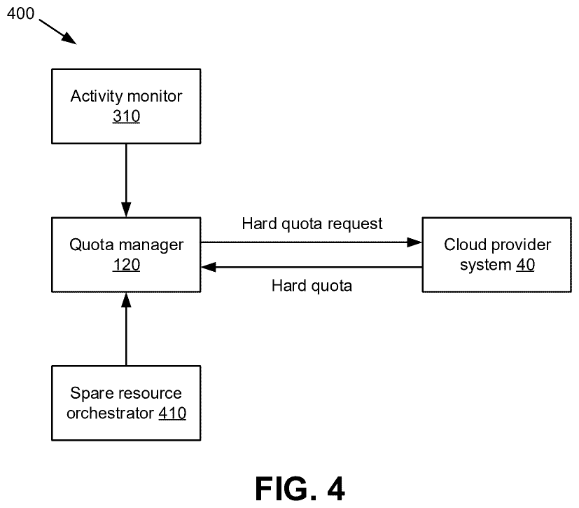

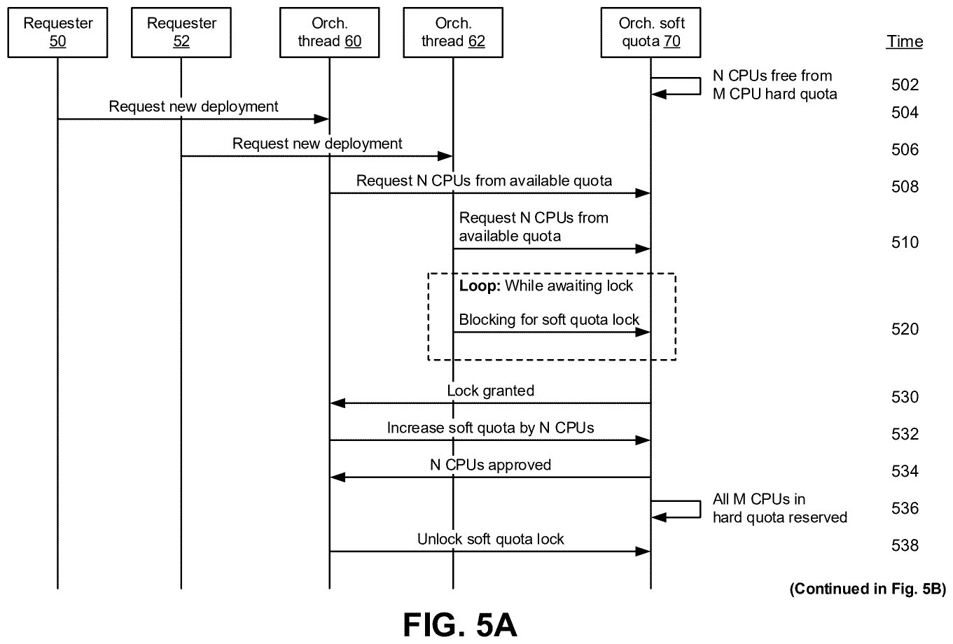

In response to receiving a request to create a new deployment, the request processor 110 can consult the quota manager 120 to determine whether sufficient unreserved resources associated with the cloud computing service 10 exist to fulfill the request. In an implementation, the request processor 110 can compare a requested amount of a computing resource associated with a new deployment requested by the requesting system 30 to a difference between a hard quota for the resource, i.e., a resource quota of the computing resource as allocated for the cloud computing service 10 by a provider of the cloud computing service 10, and a soft quota for the resource, i.e., a reserved amount of the computing resource reserved by VMs 22 associated with the cloud computing service 10. The quota manager 120 can maintain information relating to the hard quota and the soft quota for the resource, e.g., as will be described in further detail below with reference to FIGS. 3-4.

In response to the difference between the hard and soft quotas for the resource being determined not to be less than the requested amount of the computing resource, the request processor 110 can determine that sufficient unreserved resources exist to create the deployment. Accordingly, the cloud resource orchestrator 130 can add the requested amount of the computing resource to the soft quota, e.g., by incrementing the reserved amount of the resource as maintained by the quota manager 120 by the requested amount, and enable creation of the new deployment within the cloud computing service 10. In contrast, In response to the difference between the hard and soft quotas for the resource being determined to be less than the requested amount of the computing resource, the request processor 110 can determine that sufficient unreserved resources do not exist to create the deployment, and the request processor 110 can deny the request to create the new deployment.

As further shown in FIG. 1, the communication module 140 can notify the requesting system 30 of the outcome of its deployment request, e.g., by transmitting details regarding the new deployment to the requesting system 30 in the event of a successful request and/or transmitting a failure message or other notification to the requesting system 30 in the event of an unsuccessful request.

In an implementation in which the cloud computing service 10 shown in FIG. 1 operates on the public cloud, a cloud provider associated with the cloud computing service 10 can enforce limits on specific resources for a given SaaS provider (e.g., a SaaS provider associated with system 100) via quotas. Resources that can be limited via quotas in this manner can include processor units for a given VM product family or stock keeping unit (SKU), storage volumes or other storage units, and/or any other suitable resource. By way of example, a SaaS provider can be given N CPUs total that can be consumed as VMs in a given family are created. When a VM is deployed, the used CPU count can be increased. Similarly, when a VM is deallocated (e.g., such that the VM resource is visible but not using any quota) or destroyed (i.e., deleted completely), the used CPU count can decrease and the available CPU count can increase. It is noted that the quota does not change in either of the above cases; instead, the number of used CPUs within the quota can move up and down as a direct result of VMs being created, deallocated, or deleted.

When a user subscribes to a SaaS solution, an orchestration software (e.g., implemented by one or more of the components of system 100 and/or other components as will be described herein) can deploy a set of VMs, and the used CPU count can be increased when the resources are created successfully. A call to a quota application programming interface (API) associated with the cloud provider can be used to reflect that the resources have been used.

In the above workflow, there is a set of situations in which race conditions may occur when the quota is nearly all consumed. For example, issues can arise when multiple users attempt to onboard concurrently. By way of a non-limiting example, consider a scenario in which there is a 100 CPU quota from which 15 CPUs are remaining, two users are attempting to deploy a cluster concurrently, and a cluster takes 10 total CPUs to deploy. In this scenario, by only checking the available CPUs remaining in the quota via the cloud provider API, orchestration software will see that sufficient free resources remain and will allow both requests to proceed. However, during the deployment, either one user will get a deployment and the other user a failure, or both will get a partial deployment resulting in failure for both.

In another example, issues can also arise when previously allocated resources associated with an existing user are undergoing maintenance while another user is onboarding. In this situation, a user can attempt to perform a node (e.g., VM) replacement while the SaaS solution is near full capacity. Before starting the replacement, the orchestration software can check the quota and see that sufficient resources are available in the quota for the node replacement. However, after starting the workflow, an onboarding user may have taken the remaining quota, causing the node replacement to fail.

The above are examples of situations in which checking against the cloud provider hard quota is not sufficient for a SaaS platform to detect resources that are owned. To mitigate this, system 100 can maintain and utilize an additional parameter referred to as soft quotas. When a SaaS solution associated with system 100 is deployed in production, system 100 can keep track of the hard quota for various resources, such as the CPU count allocated to the SaaS provider. An API call to the cloud provider can provide the hard quota as well as the amount of resources used in that quota. When a user is onboarded, e.g., via a request from a requesting system 30 as shown in FIG. 1, system 100 can check the soft quota against the hard quota to determine if sufficient free resources are present for the deployment. This can enable ongoing operations to continue undisrupted in the event that the used resources are nearing the hard quota limit.

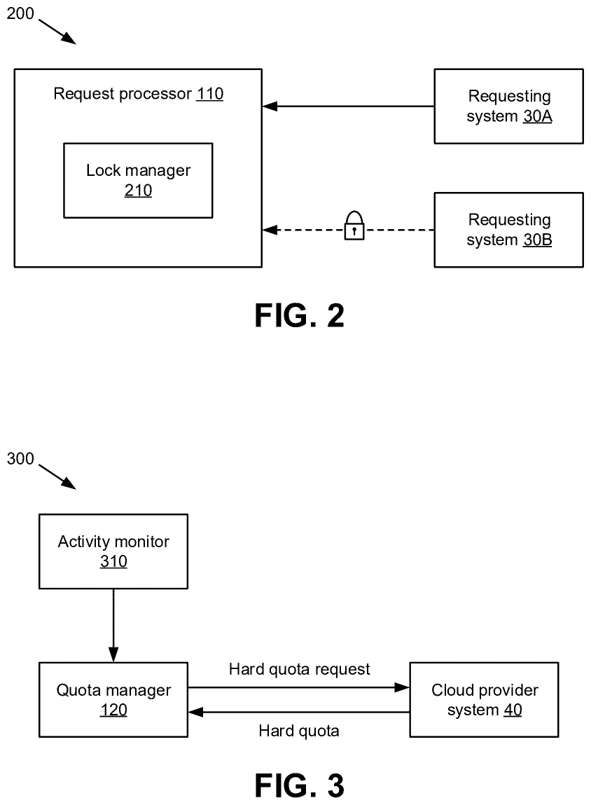

Various implementations as described herein can give a SaaS provider the ability to leverage existing capabilities exposed by cloud providers, such as resource quotas, and apply business logic on top of those capabilities to ensure that concurrent lifecycle management operations can be performed safely. Additionally, implementations as described herein can be designed in a way that ensures that no threads are blocked on lifecycle management operations to complete. Instead, upon being granted resources, a lock can be released and made available to any other thread in the environment, thus providing for a higher performing system. Further details regarding locks and/or other mechanisms to perform resource management via atomic operations are described in further detail below with respect to FIG. 2.

In addition, implementations as described herein can provide the ability to ensure that lifecycle management actions can safely be performed against resources in the cloud, such as a CPU count for VMs, without risking being stranded in the middle of a workflow. In the scenario in which there are no resources available, failures can be returned in a cleaner manner back to the requesting user.

With reference next to FIG. 2, a block diagram of another system 200 that facilitates soft quotas for cloud resource management is illustrated. Repetitive description of like parts described above with regard to other implementations is omitted for brevity. System 200 includes a request processor 110, which can handle requests to create and/or modify deployments associated with a cloud computing service 10 (not shown in FIG. 2) in a similar manner to that described above with respect to FIG. 1. In an implementation, the request processor 110 of system 200 can process requests from respective requesting systems 30 as atomic operations, e.g., such that a request from a first requesting system 30A is processed fully and without interruption before a subsequent request from another requesting system 30B is processed. In this way, the request processor 110 can ensure that resources to be allocated in response to a given initial request are not taken mid-operation by requests that come in after the initial request.

In one implementation, the request processor 110 can enforce atomic operations for incoming requests by facilitating all processing of a given request, including verifying that sufficient quota for a given request exists and then updating the quota upon successful verification, in a single operation or set of operations that are executed without interruption. In another implementation, the request processor 110 can, e.g., via a lock manager 210, issue a lock to a given requesting system (e.g., requesting system 30A in FIG. 2) in response to receiving a request from that system. This lock can prevent other requests, other than the request from the requesting system 30A for which the lock was issued, from being processed. In response to that request being resolved (e.g., either by granting or denying the request, as described above with respect to FIG. 1), the lock can be released, thereby enabling other requests from other requesting systems (e.g., requesting system 30B in FIG. 2) to be processed.

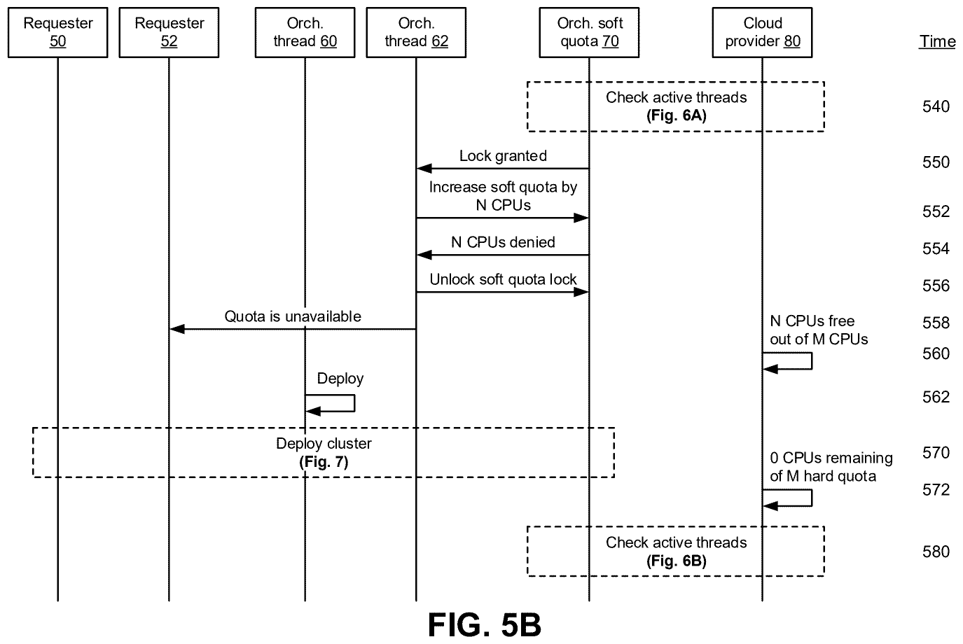

Turning now to FIG. 3, a block diagram of still another system 300 that facilitates soft quotas for cloud resource management is illustrated. Repetitive description of like parts described above with regard to other implementations is omitted for brevity. System 300 as shown in FIG. 3 includes an activity monitor 310 that can monitor a number of active resource orchestration threads associated with a cloud computing service, e.g., a cloud computing service 10 as described above with respect to FIG. 1. Resource orchestration threads tracked by the activity monitor 310 can correspond to active requests for cloud resources being processed by the request processor 110, e.g., as described above and as will be further described below with respect to FIGS. 5A-5B.

In response to determining that no resource orchestration threads are active, the activity monitor 310 can cause the quota manager 120 to retrieve information relating to an unused amount of a computing resource (e.g., CPUs, storage volumes, etc.) remaining in a resource quota (hard quota) from a provider system 40 associated with the cloud computing service 10. As shown in FIG. 3, this can be done by submitting a request from the quota manager 120 to the provider system 40 over a cloud platform API and/or any other suitable interface between the quota manager 120 and the provider system 40.

By utilizing the activity monitor 310 as shown in FIG. 3, the quota manager 120 can facilitate synchronizing the hard quota associated with the provider system 40 with the soft quota maintained by the quota manager at times in which the soft and hard quotas are not expected to differ due to the absence of resource orchestration activity. This can, in turn, enable the quota manager 120 to ensure that it has the correct state according to the provider system 40, accounting for any failures, maintenance events, or the like that may have occurred while any resource orchestration threads were active.

As further shown by system 400 in FIG. 4, the quota manager 120 can additionally reserve spare computing resources on top of the hard quota retrieved from the provider system 40. To this end, system 400 can include a spare resource orchestrator 410 that can, subsequent to the quota manager 120 synchronizing the soft and hard quotas (e.g., by setting a reserved amount of a computing resource to an unused amount of the computing resource remaining in a quota allotted by the provider system 40), cause the quota manager 120 to increment the reserved amount of the resource by a designated spare amount of the resource. In an implementation, this designated spare amount can be determined by the spare resource orchestrator 410 as a function of an amount of the resource that is allocated to respective VMs associated with the underlying cloud computing service.

The spare resource orchestrator of system 400 can be utilized to ensure that the quota manager 120 maintains spare resources for an additional VM in the event of a hard failure. To do this, the spare resource orchestrator 410 can determine the number of deployed clusters per geographical region, e.g., in an implementation in which cloud provider quotas are allocated on a per-region basis. For each deployed cluster, the spare resource orchestrator 410 can further determine the number of CPUs or other resources per VM (e.g., since clusters are homogenous) and add the total amount of resources needed to support a replacement VM within that cluster to the soft quota maintained by the quota manager 120. In various implementations, the spare resource orchestrator 410 can facilitate reservation of spare resources on a per-deployment and/or per-region basis.

By reserving spare resources via the spare resource orchestrator 410, system 400 can facilitate faster recovery in the event of a VM failure. For instance, when a SaaS solution deploys a cluster, the spare resource orchestrator 410 can provide enough spare resources for a node replacement in the event of a failure. Without this extra reservation (e.g., in implementations that utilize only the hard quota), scenarios can arise in which recovery from a VM failure will be slower compared to a system in which sufficient resources for deploying an additional VM are reserved.

Turning next to FIGS. 5A-5B, 6A-6B, and 7, diagrams illustrating respective procedures that can be performed in connection with one or more implementations described herein are illustrated. Referring first to FIGS. 5A-5B, an example procedure that can be performed by two requesting systems 50, 52, two corresponding orchestration threads (e.g., as implemented by the request processor 110 and/or quota manager 120 of system 100) 60, 62, a soft quota orchestrator 70 (e.g., as implemented by the quota manager 120 of system 100), and a cloud provider system 80 is illustrated. In the example shown by FIGS. 5A-5B, the requesting systems 50, 52 are each requesting a new deployment, but it is noted that other requests, such as requests to expand an existing deployment, could be handled in a similar manner to that shown by FIGS. 5A-5B.

The procedure shown by FIGS. 5A-5B begins at time 502 in FIG. 5A, in which the soft quota orchestrator 70 determines that there are N CPUs free out of a hard quota of M CPUs. Next, at times 504 and 506, requesting systems 50 and 52, respectively request to be onboarded. At times 508 and 510, respective orchestration threads 60, 62 corresponding to the requesting systems 50, 52 can request N CPUs for the corresponding requested deployments.

As shown in FIG. 5A, a soft quota lock can be granted to one of the threads 60, 62, enabling the granted thread to deploy while the other thread is instructed to wait. Here, at time 520, orchestration thread 62 is configured to wait until it is granted the soft quota lock, and the soft quota orchestrator 70 grants the lock to orchestration thread 60 at time 530. At time 532, orchestration thread 60 can request N CPUs in response to receiving the lock at time 530. Since N CPUs are free in the soft quota, the soft quota orchestrator 70 can grant the request at time 734. As a result, at time 536, the soft quota orchestrator 70 can update its reserved amount of CPUs, e.g., such that all M CPUs in the hard quota are designated as reserved. Orchestration thread 60 can then release its lock at time 538, enabling orchestration thread 62 to submit its request.

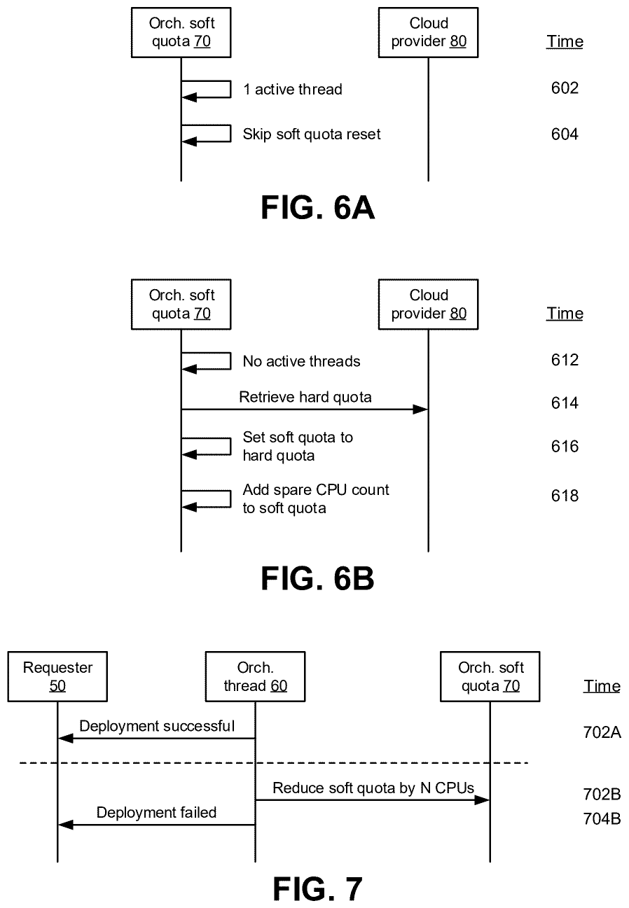

Continuing on to FIG. 5B, the soft quota orchestrator 70 can execute a sub-procedure to check whether any orchestration threads are active, as shown by FIG. 6A. As illustrated by FIG. 6A, the soft quota orchestrator 70 can determine at time 602 that one orchestration thread (e.g., orchestration thread 62) is still active. Thus, at time 604, the soft quota orchestrator 70 can skip a soft quota reset (e.g., as described above with respect to FIGS. 3-4) and return to the procedure shown in FIG. 5B.

At time 550, the soft quota orchestrator 70 can grant a lock to orchestration thread 62, in response to which orchestration thread 62 can request N CPUs at time 552 in a similar manner to the request submitted by orchestration thread 60 described above. Here, however, no CPUs remain in the available soft quota, and as a result the soft quota orchestrator 70 can deny the request at time 554. Subsequently, at time 556, the lock granted to orchestration thread 62 can be released, and at time 558, orchestration thread 62 can return a failure message to its corresponding requesting system 52, e.g., indicating that sufficient quota is not available for the request. In some implementations, this notification could instruct the requesting system 52 to retry the request at a future time.

By utilizing soft quotas via the soft quota orchestrator 70, the soft quota orchestrator 70 can deny the request from orchestration thread 62 even though, as shown at time 560, the hard quota maintained by the cloud provider 80 still reflects that N CPUs are available out of the original M CPU hard quota. This can prevent situations in which the orchestration threads 60, 62 are both granted only a portion of the requested resources, which can cause one or both orchestration threads 60, 62 to fail.

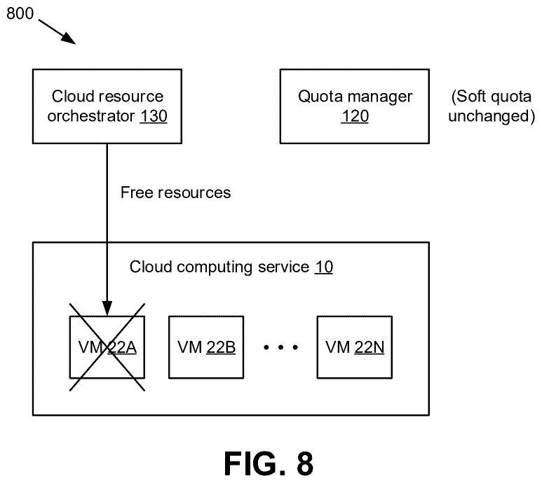

At time 562, because the request issued by orchestration thread 60 was granted and N CPUs remain available in the hard quota (e.g., as shown at time 560), orchestration thread 60 can initialize deployment of the requested cluster, which can occur at time 570 by executing a sub-procedure as shown in FIG. 7. As FIG. 7 illustrates, the sub-procedure can vary depending on whether the deployment is successful. In the event that deployment of the cluster is successful, the sub-procedure can proceed as shown at time 702A, in which orchestration thread 60 reports success of the deployment back to its corresponding requesting system 50. Alternatively, if the deployment fails, the sub-procedure can instead proceed as shown at time 702B, in which orchestration thread 60 can instruct the soft quota orchestrator 70 to revert the incrementing of the reserved CPUs in the soft quota that occurred at time 534, thereby unreserving the requested N CPUs and making them available again in the soft quota. Orchestration thread 60 can then report the failure to requesting system 50, as shown at time 704B.

Returning to FIG. 5B, in the event of a successful deployment at time 570, the hard quota can be updated at the cloud provider 80 at time 572 to indicate that there are no CPUs remaining in the original M CPU hard quota. Finally, at time 580, the soft quota orchestrator 70 can execute another sub-procedure to check its active orchestration threads, as shown by FIG. 6B. As illustrated by FIG. 6B, the soft quota orchestrator 70 can synchronize its soft quota with the hard quota by retrieving the hard quota from the cloud provider 80 at time 614 and setting the soft quota to the retrieved hard quota at time 616 (e.g., as described above with respect to FIG. 3). At time 618, the soft quota orchestrator 70 can also add a designated spare CPU count to the soft quota, e.g., as described above with respect to FIG. 4.

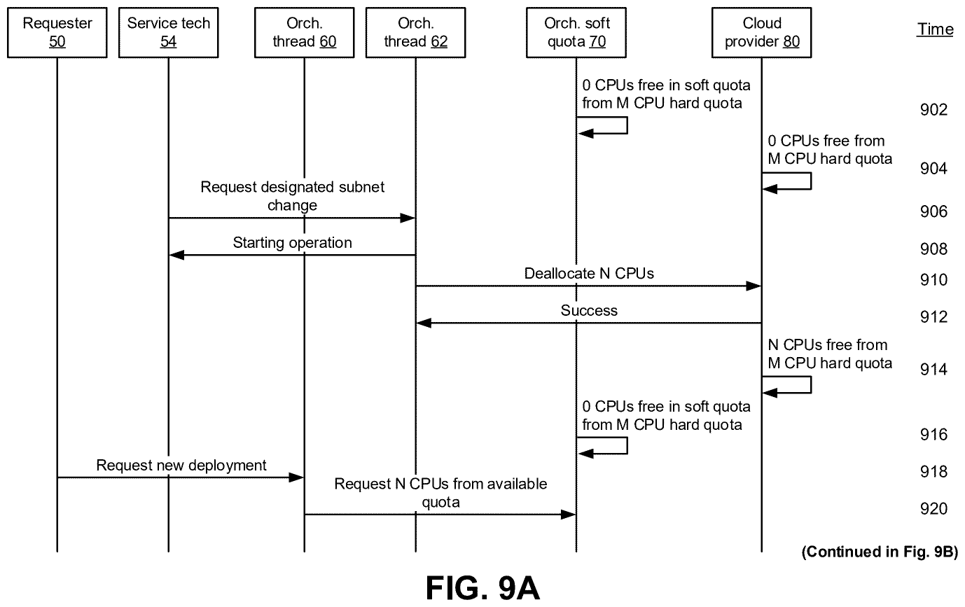

With reference now to FIG. 8, a block diagram of another system 800 that facilitates soft quotas for cloud resource management is illustrated. Repetitive description of like parts described above with regard to other implementations is omitted for brevity. System 800 as shown in FIG. 8 includes a cloud resource orchestrator 130, which can manage resources associated with one or more deployed VMs 22, here N VMs 22A-22N, associated with a cloud computing service 10. System 800 also includes a quota manager 120 that can manage a soft quota, e.g., corresponding to reserved resources associated with the cloud computing service 10.

The quota manager 120 and cloud resource orchestrator 130 of system 800 can facilitate separation between reserved resources and allocated resources, e.g., to preserve access to unallocated resources during a given workflow. Thus, for example, in response to a VM, here VM 22A, failing or otherwise becoming unavailable, the cloud resource orchestrator 130 can free the resources utilized by the unavailable VM 22A without the quota manager 120 unreserving those resources, e.g., by altering the reserved resource amount given by the soft quota.

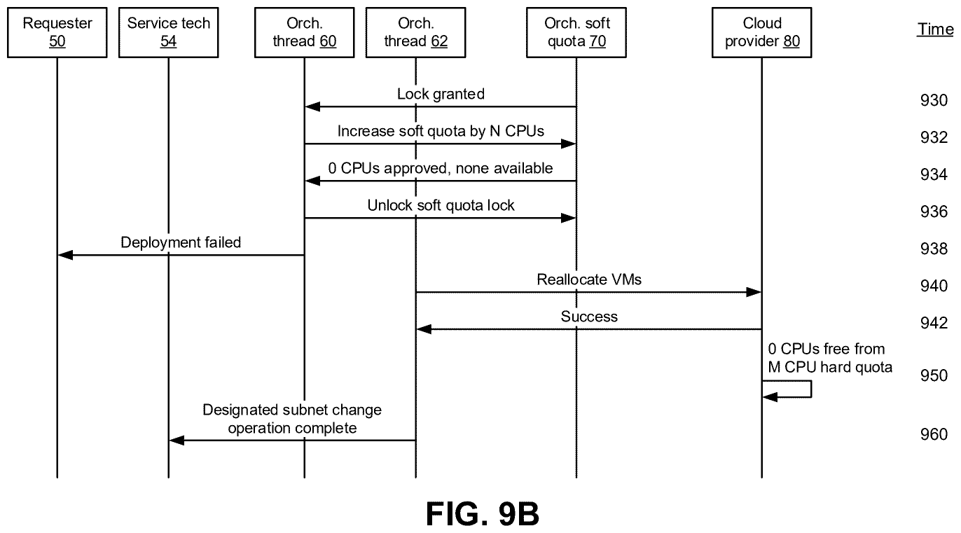

An example workflow that further illustrates the above principle is shown by FIGS. 9A-9B, which illustrate an example procedure that can be performed by a requesting system 50, a service tech 54, orchestration threads 60, 62 respectively corresponding to the requesting system 50 and the service tech 54, a soft quota orchestrator 70, and a cloud provider 80. In the example shown by FIGS. 9A-9B, a new user, represented by the requesting system 50, is attempting to onboard while there is a maintenance operation occurring (e.g., initiated by the service tech 54) where another user's resources need to be deallocated.

As shown at times 902 and 904 in FIG. 9A, there are no CPUs available in either the soft quota or hard quota, respectively, at the beginning of the procedure. Next, at time 906, the service tech 54 initiates a maintenance operation that will deallocate all of the VMs of the corresponding cluster, and a corresponding orchestration thread 62 begins this operation at time 908. At time 910, orchestration thread 62 executes the operation by deallocating N CPUs corresponding to the cluster at the cloud provider 80, and at time 912 the cloud provider 80 reports that the deallocation was carried out successfully.

As a result of the above, as shown at time 914, there are N CPUs available in the hard quota. However, as further shown at time 916, the soft quota remains fully utilized. Subsequently, at time 918, a requesting system 50 can request a new deployment, and orchestration thread 60 can request N CPUs from the soft quota orchestrator 70 at time 920. Continuing to FIG. 9B, the soft quota orchestrator 70 can grant a lock to orchestration thread 60 at time 930 in response to receiving the request, and orchestration thread 60 can request to increase the soft quota by N CPUs at time 932.

In an implementation that does not utilize soft quota checks, an onboarding user requesting N CPUs, such as that shown at time 932, would be able to take the remaining quota of CPUs while there is a maintenance operation in progress, which would cause the cluster undergoing maintenance to fail when the maintenance completes. In contrast, by using a soft quota algorithm, the soft quota orchestrator 70 can, at time 934, determine that there are no unreserved CPUs available and return a failure. At time 936, processing of the request from orchestration thread 60 can conclude by releasing the lock granted to orchestration thread 60 at time 930. Additionally, at time 938, orchestration thread 60 can report the failure of the request back to the requesting system 50.

At time 940, the maintenance operation has completed, and as a result the corresponding VMs are reallocated at the cloud provider 80 and the cluster boots back up. At time 942, the cloud provider 80 reports success of the reallocation back to orchestration thread 62. It is noted that the soft quota does not change as a result of reallocating the VMs, as the soft quota already accounted for the VMs to be reallocated. As further shown by FIG. 9B, the request from orchestration thread 62 made at time 940 to reallocate the VMs can be provided directly to the cloud provider 80 without consulting the soft quota orchestrator 70, e.g., since a one-to-one reallocation (i.e., that does not alter the total number of deployed VMs) is to be performed.

However, as shown at time 950, the hard quota utilization returns to full usage in response to reallocation of the VMs. Finally, at time 962, orchestration thread 62 reports to the service tech 54 that the operation has completed successfully.

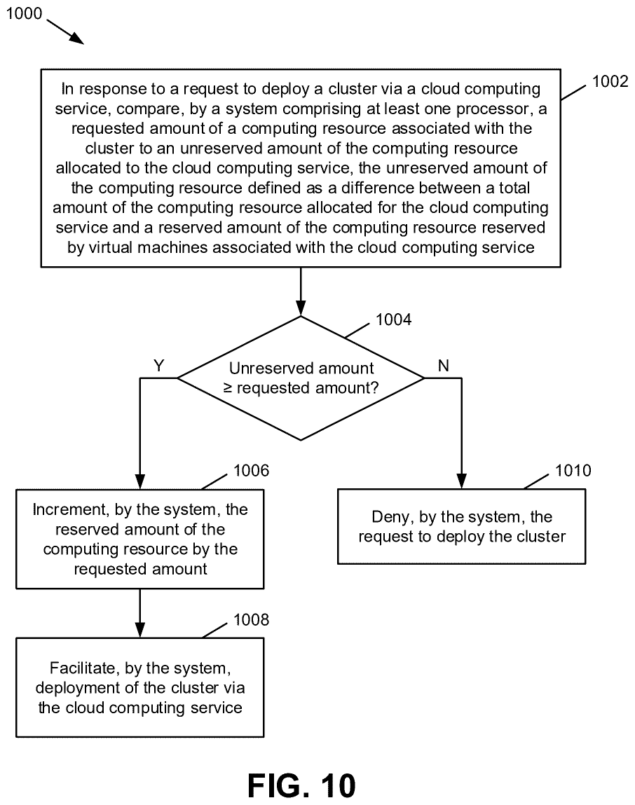

Turning to FIG. 10, a flow diagram of a method 1000 that facilitates soft quotas for cloud resource management is illustrated. At 1002, in response to a request to deploy a cluster (e.g., a cluster corresponding to a cloud deployment 20) via a cloud computing service (e.g., a cloud computing service 10), a system comprising at least one processor can compare (e.g., by a request processor 110) a requested amount of a computing resource (e.g., CPUs, storage volumes, etc.) associated with the cluster to an unreserved amount of the computing resource allocated to the cloud computing service. The unreserved amount of the computing resource can be defined as a difference between a total amount of the computing resource allocated for the cloud computing service (e.g., a hard quota maintained by a cloud provider system 40) and a reserved amount of the computing resource reserved by VMs (e.g., VMs 22) associated with the cloud computing service (e.g., a soft quota as maintained by a quota manager 120).

At 1004, method 1000 can branch based on whether the unreserved resource amount is greater than or equal to (no less than) the requested resource amount. If the unreserved amount is determined to be no less than the requested amount, method 1000 can proceed from 1004 to 1006, at which the system can increment (e.g., by the quota manager 120) the reserved amount of the computing resource by the requested amount. Method 1000 can then conclude at 1008, at which the system can facilitate (e.g., by a cloud resource orchestrator 130) deployment of the cluster via the cloud computing service.

Alternatively, if the unreserved resource amount is determined at 1004 to be less than the requested resource amount, method 1000 can instead proceed from 1004 to 1010, at which the system can (e.g., via the request processor 110 and/or a communication module 140) deny the request to deploy the cluster.

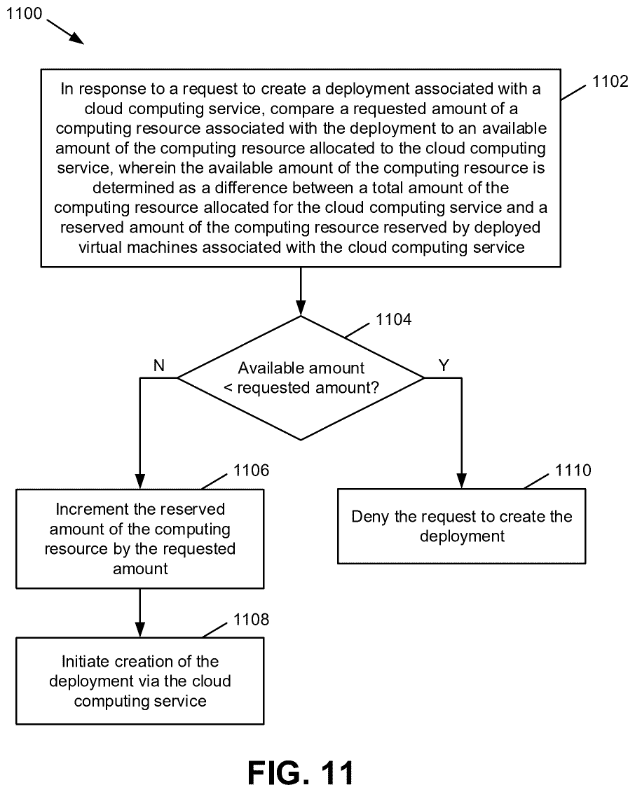

Referring next to FIG. 11, a flow diagram of a method 1100 that can be performed by at least one processor, e.g., based on machine-executable instructions stored on a non-transitory machine-readable medium, is illustrated. An example of a computer architecture, including a processor and non-transitory media, that can be utilized to implement method 1000 is described below with respect to FIG. 12.

Method 1100 can begin at 1102, in which the at least one processor can, in response to a request to create a deployment associated with a cloud computing service, compare a requested amount of a computing resource associated with the deployment to an available amount of the computing resource allocated to the cloud computing service. The available amount of the computing resource can be determined as a difference between a total amount of the computing resource allocated for the cloud computing service (e.g., a hard quota) and a reserved amount of the computing resource reserved by deployed VMs associated with the cloud computing service (e.g., a soft quota).

At 1104, method 1100 can branch based on whether the available resource amount is less than the requested resource amount. If the available resource amount is determined at 1104 to not be less than the requested resource amount, method 1100 can proceed to 1106, at which the at least one processor can increment the reserved amount of the computing resource by the requested amount, and to 1108, at which the at least one processor can initiate creation of the deployment via the cloud computing service.

Alternatively, if the available resource amount is determined at 1104 to be less than the requested resource amount, method 1100 can instead proceed to 1108, at which the at least one processor can deny the request to create the deployment.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 12 and the following discussion are intended to provide a brief, general description of a suitable computing environment 1200 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example general-purpose environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
comparing, in response to a request to create a new deployment associated with a cloud computing service, a requested amount of a computing resource associated with the new deployment to a difference between a resource quota of the computing resource as allocated for the cloud computing service and a reserved amount of the computing resource reserved by virtual machines associated with the cloud computing service;
in response to the difference being determined not to be less than the requested amount of the computing resource, incrementing the reserved amount of the computing resource by the requested amount of the computing resource and enabling creation of the new deployment within the cloud computing service; and
in response to the difference being determined to be less than the requested amount of the computing resource, denying the request to create the new deployment.

2. The system of claim 1, wherein the operations further comprise:
processing the request to create the new deployment as an atomic operation.

3. The system of claim 2, wherein the processing comprises:
issuing a lock to a requesting system associated with the request to create the new deployment, wherein the lock prevents other requests, other than the request to create the new deployment, from being processed, and
releasing the lock, thereby enabling the other requests to be processed, in response to a resolution of the request to create the new deployment, the resolution being selected from a group consisting of the enabling of the creation of the new deployment and the denying of the request to create the new deployment.

4. The system of claim 1, wherein the operations further comprise:
monitoring a number of active resource orchestration threads associated with the cloud computing service; and
in response to determining, via the monitoring, that no resource orchestration threads associated with the cloud computing service are active, retrieving information relating to an unused amount of the computing resource remaining in the resource quota from a provider system associated with the cloud computing service.

5. The system of claim 4, wherein the operations further comprise:
setting the reserved amount of the computing resource to the unused amount of the computing resource remaining in the resource quota; and
incrementing the reserved amount of the computing resource by a designated spare amount of the computing resource.

6. The system of claim 5, wherein the operations further comprise:
determining the designated spare amount of the computing resource as a function of an amount of the computing resource allocated to respective ones of the virtual machines associated with the cloud computing service.

7. The system of claim 1, wherein the operations further comprise:
in response to a virtual machine, of the virtual machines associated with the cloud computing service, being determined to have become unavailable, freeing an amount of the computing resource utilized by the virtual machine without altering the reserved amount of the computing resource.

8. The system of claim 1, wherein the operations further comprise:
reverting the incrementing of the reserved amount of the computing resource in response to the creation of the new deployment within the cloud computing service being determined to have failed.

9. The system of claim 1, wherein the computing resource comprises at least one of processor units or storage units usable by the virtual machines associated with the cloud computing service.

10. The system of claim 1, wherein the operations further comprise:
in further response to the difference being determined to be less than the requested amount of the computing resource, transmitting a failure message to a requesting system associated with the request.

11. A method, comprising:
in response to a request to deploy a cluster via a cloud computing service, comparing, by a system comprising at least one processor, a requested amount of a computing resource associated with the cluster to an unreserved amount of the computing resource allocated to the cloud computing service, the unreserved amount of the computing resource defined as a difference between a total amount of the computing resource allocated for the cloud computing service and a reserved amount of the computing resource reserved by virtual machines associated with the cloud computing service;
in response to the unreserved amount of the computing resource being greater than or equal to the requested amount, incrementing, by the system, the reserved amount of the computing resource by the requested amount and facilitating deployment of the cluster via the cloud computing service; and
in response to the unreserved amount of the computing resource being less than the requested amount, denying, by the system, the request to deploy the cluster.

12. The method of claim 11, further comprising:
monitoring, by the system, a number of active resource orchestration threads associated with the cloud computing service; and
in response to determining, based on a result of the monitoring, that no resource orchestration threads associated with the cloud computing service are active, retrieving, by the system from a provider system associated with the cloud computing service, information relating to an unused amount of the computing resource remaining in the total amount of the computing resource allocated for the cloud computing service.

13. The method of claim 12, further comprising:
setting, by the system, the reserved amount of the computing resource to a sum of the unused amount of the computing resource and a designated spare amount of the computing resource.

14. The method of claim 13, further comprising:
determining, by the system, the designated spare amount of the computing resource as a function of an amount of the computing resource allocated to respective ones of the virtual machines associated with the cloud computing service.

15. The method of claim 11, wherein the computing resource comprises processor units usable by the virtual machines associated with the cloud computing service.

16. A non-transitory machine-readable medium comprising computer executable instructions that, when executed by at least one processor, facilitate performance of operations, the operations comprising:
in response to a request to create a deployment associated with a cloud computing service, comparing a requested amount of a computing resource associated with the deployment to an available amount of the computing resource allocated to the cloud computing service, wherein the available amount of the computing resource is determined as a difference between a total amount of the computing resource allocated for the cloud computing service and a reserved amount of the computing resource reserved by deployed virtual machines associated with the cloud computing service;
in response to the available amount of the computing resource being determined not to be less than the requested amount, incrementing the reserved amount of the computing resource by the requested amount and initiating creation of the deployment via the cloud computing service; and
in response to the available amount of the computing resource being determined to be less than the requested amount, denying the request to create the deployment.

17. The non-transitory machine-readable medium of claim 16, wherein the operations further comprise:
monitoring a number of active resource orchestration threads associated with the cloud computing service; and
in response to determining, via the monitoring, that there are no active resource orchestration threads associated with the cloud computing service, obtaining, from a provider system associated with the cloud computing service, information relating to an unused amount of the computing resource remaining in the total amount of the computing resource allocated for the cloud computing service.

18. The non-transitory machine-readable medium of claim 17, wherein the operations further comprise:
setting the reserved amount of the computing resource to a sum of the unused amount of the computing resource and a specified spare amount of the computing resource.

19. The non-transitory machine-readable medium of claim 18, wherein the operations further comprise:
determining the specified spare amount of the computing resource as a function of an amount of the computing resource allocated to respective ones of the deployed virtual machines associated with the cloud computing service.

20. The non-transitory machine-readable medium of claim 16, wherein the computing resource comprises processor units usable by the deployed virtual machines associated with the cloud computing service.
